(19) United States
(12) Patent Application Publication
(10) Pub. No.: US 2010/0268421 A1
(43) Pub. Date: Oct. 21, 2010

(54) METHOD OF RETURNING STEERING WHEEL USING MOTOR

(75) Inventors: SEUNGHOON YANG, Yongin-si (KR); SEOKCHAN YUN, Yongin-si (KR); HYUNGJU KWON, Yongin-si (KR)

Correspondence Address: KNOBBE MARTENS OLSON & BEAR LLP, 2040 MAIN STREET, FOURTEENTH FLOOR, IRVINE, CA, 92614, US

(73) Assignee: HYUNDAI MOBIS CO., LTD., SEOUL (KR)

(21) Appl. No.: 12/732,133

(22) Filed: Mar. 25, 2010

(30) Foreign Application Priority Data
Apr. 17, 2009 (KR) 10-2009-0033473 A

(51) Int. Cl. G06F 19/00

(52) U.S. Cl. 701/41

(57) ABSTRACT

A method of returning a steering wheel includes measuring steering torque and speed of a vehicle. A returning torque is determined using the measured torque, the measured speed and friction characteristics of a steering system. A motor is operated to rotate a steering wheel based on the returning torque.

### CROSS-REFERENCE TO RELATED APPLICATIONS

The present application claims priority to Korean Patent Application Number 10-2009-0033473 filed Apr. 17, 2009, the entire contents of which application is incorporated herein for all purposes by this reference.

### BACKGROUND

1. Field

The present disclosure relates to steering return, particularly a steering return method without using a steering angle sensor in an electric power steering system.

2. Description of Related Art

In general, drivers slowly take their hands off the steering wheel when determining that a vehicle has turned at a predetermined angle, after inputting a predetermined torque to the steering wheel to turn the vehicle, but the steering wheel returns to the center.

This function is called returning of steering wheel, and in general, useful when a vehicle turns at a low velocity.

However, a self alignment torque applied to a steering wheel is insufficient for the steering wheel to return to the center, which is because the friction force in the steering system causes a steering-remaining angle, and about 45° or more return-remaining angle remains.

Accordingly, specific function helping the return function is required to help the steering wheel to completely return to the center.

For example, by using a steering angle sensor, it is possible to implement return function that maintains the return-remaining angle within ±5°, as compared with when return function is not provided.

As described above, when a method using a steering angle sensor to minimize the return-remaining angle is applied to MDPS (Motor Driven Power Steering), which is a motor driven steering system, return function is achieved by using a steering angle sensor to calculate return torque and applying a value calculated by using the steering angle sensor to an MDPS motor.

The MDPS does not use hydraulic pressure, includes a motor for power generation controlled by an ECU and a worm shaft and a worm wheel that are rotated by the motor, and assists steering force by rotating the steering shaft using the worm wheel.

However, the MDPS system has a defect in that the cost increases and the competitiveness of the product is weakened, when using the steering angle senor for the return function.

The information disclosed in this Background section is only for enhancement of understanding of the general background and does not constitute an admission of prior art already known to a person skilled in the art.

### SUMMARY

Various aspects of the present invention are directed to provide an MDPS (Motor Driven Power Steering) which is a motor driven steering system having a return logic using a torque sensor that remains the return-remaining angle of a steering wheel within ±5°, without using a steering angle sensor increasing the cost.

In an aspect of the present invention, a steering return method for a motor driven steering system includes: an initial setting step of measuring a steering torque T, using a torque sensor with respect to operation of a steering wheel when a vehicle is turned; a condition initial setting step of applying gains for velocities, using measured velocity V of the vehicle turning; a logic implementation setting step of calculating control factor for return of the steering wheel, such as a steering torque sign Ts, a hand-covered condition of the steering wheel S, steering reaction force Sr, and a friction compensation torque Tf, using the measured steering torque T and a total assist torque demand Tt obtained by multiplying a motor torque by a gear ratio when measuring the steering torque T; and a logic implementing step of calculating an active return torque demand generating needed motor torque by using the steering torque sign Ts, the hand-covered condition of the steering wheel S, the steering reaction force Sr, and the friction compensation torque Tf, and controlling a motor on the basis of the active return torque demand Tad.

The condition initial setting step is implemented only when the velocity V of the vehicle is within 5 km/h˜30 km/h, and acquires velocity gain Vg values by dividing the velocity region of 5 km/h˜30 km/h into a plurality of velocity regions.

The steering torque sign Ts determines the positive or the negative for a steering torque T above a predetermined value when steering, the hand-covered condition S of the steering wheel is determined by |T|g=0˜1 where the gain is applied to the absolute value acquired by differentiating the steering torque T, the steering reaction force Sr is calculated by the steering torque T and the total assist torque demand Tad, and the friction compensation torque Tf is calculated by applying a tuning map considering the steering reaction force Sr with frictional characteristics Sf of the steering system.

The steering torque sign Ts is defined as +1 when the steering torque T is above 1 Nm, and defined as −1 when the steering torque T is below −1 Nm.

The hand-covered condition S of the steering wheel defines the gain as 1 when the steering torque T has a torque change rate below 1 Nm/s and |T|g is set to 1, and the hand-covered condition S of the steering wheel when a driver holds the steering wheel is set to 1.

The active return torque demand Tad is calculated by multiplying all of the steering torque sign Ts, the hand-covered condition S of the steering wheel, the steering reaction force Sr, and the friction compensation torque Tf, and applied only when the value satisfies Vg×Ts×|T|g×Sr×Tf <+/−3 Nm.

According to embodiments of the present invention, since the MDPS (Motor Driven Power Steering), which is a motor driven steering system, achieves excellent steering wheel return performance using a torque sensor, it is unnecessary to use a steering angle sensor that increases the cost and deteriorates competitiveness of the product.

The methods and apparatuses according to embodiments of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a block control configuration diagram of a steering return logic according to an embodiment of the present invention.

FIGS. 2 and 3 are flowcharts of a steering return logic of a motor driven steering system according to an embodiment of the present invention.

### DETAILED DESCRIPTION OF EMBODIMENTS

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Embodiments of the present invention are described hereafter in detail with reference to the accompanying drawings, and the embodiments can be achieved in various ways by those skilled in the art and the present invention is not limited to the embodiments.

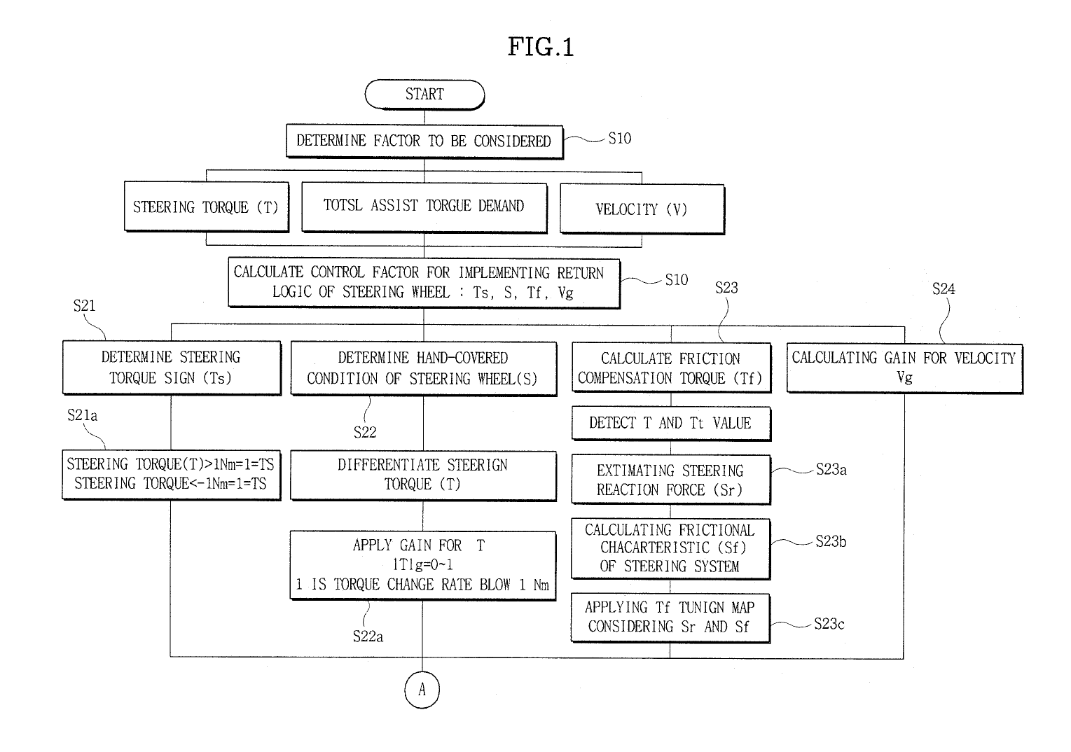

FIG. 1 is a block control configuration diagram of a steering wheel return logic according to an embodiment of the present invention. The embodiment of the present invention implements a return logic using, as a main factor, a value measured by a torque sensor of the steering wheel by an MDPS (Motor Driven Power Steering), which is a motor driven steering system, such that it can achieve excellent function of maintaining the return-remaining angle of the steering wheel within about ±5°, without using a steering angle sensor.

For this purpose, this embodiment measures a steering torque T using a torque sensor, calculates a total assist torque demand Tt obtained by multiplying a motor torque by a gear ratio, and calculates velocity or speed of a traveling vehicle to classify gains for the velocity, and then performs a process for return of the steering wheel in consideration of them, when the vehicle turns at low velocity or speed of about 5 km/h˜about 30 km/h.

The unit of the steering torque T and the total assist torque demand is Nm.

The return function of the steering wheel that is performed in this embodiment addresses maintaining the return-remaining angle of the steering wheel within about ±5°.

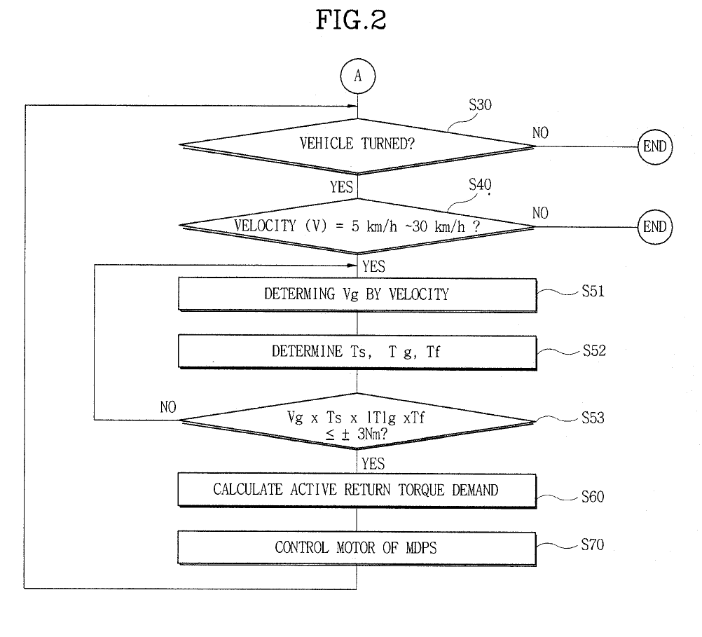

FIG. 2 shows the flow of return logic as described above. In order to implement the return logic using a torque sensor, as in step S10, it is required to determine factors to be considered for implementing the return logic, that is, detect them from the traveling vehicle.

The factors to be considered are the steering torque T detected when the steering wheel is operated, a motor assist torque Mt required to calculate steering reaction force Sr needed for substantially achieving steering, and velocity V needed for determining the condition of turning at low velocity of about 5 km/h˜about 30 km/h.

Step S11 is a step calculating control factors, which directly act, using the detected steering torque T, motor assist torque Mt, and velocity V.

The control factors are a steering torque sign Ts, hand-covered condition S of the steering wheel for determining whether a driver has taken his/her hands off the steering wheel, a friction assist torque Tf considering the friction of the steering system, and a velocity gain Vg dividing the velocity of about 5 km/h˜about 30 km/h into a plurality of velocity regions.

Step S21 is a step determining the steering torque sign Ts where a steering torque T above a predetermined value is generated when turning the vehicle, and in order to determine the positive or the negative of the steering torque sign Ts, as in Step S21a, when the steering torque sign Ts is defined as 1 when the steering torque T is above about 1 Nm, and the steering torque sign Ts is defined as −1 when the steering torque T is below about −1 Nm.

Further, step S22 is a step determining the hand-covered condition of the steering wheel to check whether the driver takes his/her hands off the steering wheel, in which the hand-covered condition S of the steering wheel is determined by the absolute value |T| obtained by differentiating the steering torque T.

In general, when the driver takes his/her hands off the steering wheel, the absolute value |T| of the differentiated value of the steering torque T is large due to the self alignment torque, but the value becomes small as time passes. Further, if the absolute value |T| decreases, the steering wheel is difficult to return to the center by the friction in the steering system.

Using these characteristics, as in step S22a, a gain is applied to the |T| and |T|g=0˜1 region is set.

In this process, the gain is defined as 1, when the steering torque T has a torque change rate below 1 Nm/s, such that it is determined that the hand-covered condition S of the steering wheel=1.

Further, step S23 is a step calculating a friction compensation torque Tf considering the friction in the steering system to generate substantial torque that is set different in accordance with the magnitude of the friction in the steering system, and for this, it estimates steering reaction force Sr that is a torque for substantially performing steering.

The steering reaction force Sr is calculated in Nm by adding the steering torque T to the total assist torque demand Tt, as in step S23a.

Next, after the estimation of the steering reaction force Sr is performed, in step S23b, the frictional characteristics Sf of the steering system are determined, and then, as in step S23c, a tuning map allowing for determination of the friction compensation torque Tf in consideration of the steering reaction force Sr with the frictional characteristics Sf of the steering system is applied.

The unit of the frictional characteristics Sf of the steering system and the friction compensation torque Tf is Nm.

The tuning map is designed in advance in consideration of several factors, such as specifications of the vehicle and the steering system, such that the tuning map determines the required optimal friction compensation torque Tf on the basis of the frictional characteristics Sf and the steering reaction force Sr of the steering system, which are continuously changed, when substantially implementing the steering return function.

Further, the velocity gain Vg is provided to implement the optimal steering return considering the region of velocity, generally divides the velocity of 5 km/h˜30 km/h into a plurality of velocity regions, which is determined in consideration of the specifications of the vehicle and the steering system.

As described above, the steering torque T is provided with +/− steering torque signs Ts, the hand-covered condition S of the steering wheel is applied to the |T|g set in 0˜1, the friction compensation torque Tf is applied to the tuning map considering the steering reaction force Sr with the frictional characteristics Sf of the steering system, and the velocity V of about 5 km/h˜about 30 km/h is applied to the velocity gain divided into the velocity gain Vg, such that the steering return function is optimally implemented by those values in the vehicle turns.

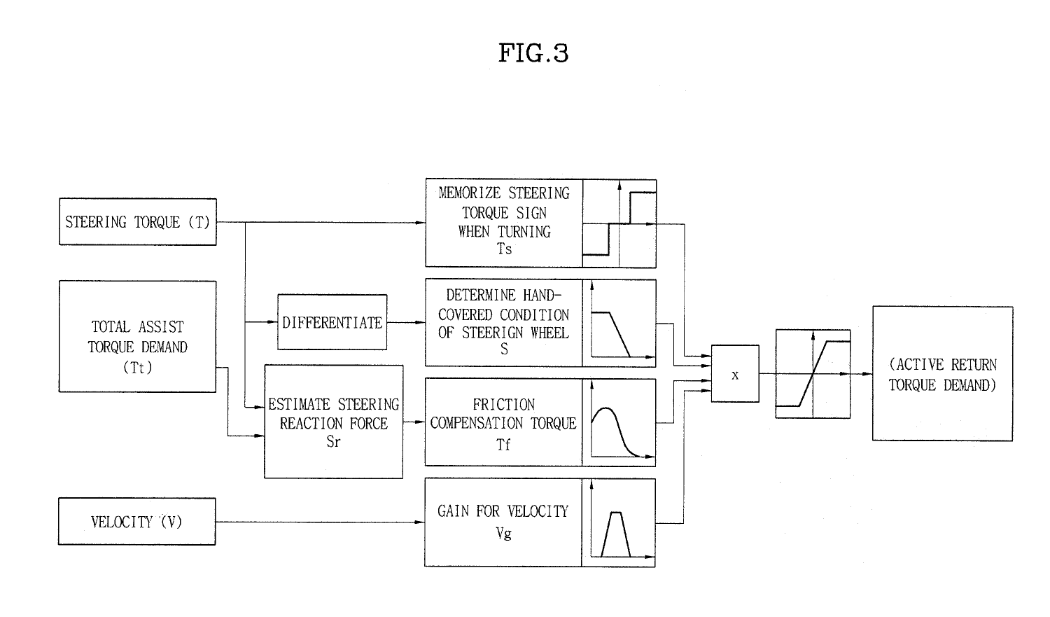

FIG. 3 illustrates a process of implementing steering return when a vehicle turns while traveling at a low velocity or speed of about 5 km/h˜about 30 km/h.

As in steps S30 and S40, when a vehicle turns and satisfies the velocity V of about 5 km/h˜30 km/h, the velocity gain Vg for the velocity V at a control point is applied as in step S51 and the steering torque T of the steering wheel at the present condition is calculated.

Further, after the steering torque T is calculated, the total assist torque demand Tt obtained by multiplying the motor torque by the gear ratio is also calculated.

Next, as in step S52, the control factors, that is, the steering torque sign Ts, the steering torque absolute value |T|g, the steering reaction force Sr, and the friction compensation torque Tf are calculated.

The steering torque sign Ts determines the positive for above 1 Nm and the negative for below 1 Nm, from 1 Nm of steering torque T, and selects the determined value.

The |T|g is determined and selected as a value ranging from 0 to 1, and the gain is 1 when the steering torque T is below 1 Nm, such that the |T|g is set to 1 and the hand-covered condition S of the steering wheel is set to 1, which means that a driver does not take his/her hands off the steering wheel.

Accordingly, when the |T|g is 0, the hand-covered condition S of the steering wheel is 0, which means that the driver has taken his/her hands off the steering wheel.

Further, the steering reaction force Sr is calculated by adding the calculated steering torque T to the total assist torque demand Tt, which is referred to as a torque required for substantial steering.

When the steering reaction force Sr is calculated as described above, a value for the friction compensation torque Tf is calculated by applying the steering reaction force Sr to the tuning map, together with the frictional characteristics Sf of the steering system.

When all the control factors, the steering torque sign Ts, steering torque absolute value |T|g, steering reaction force Sr, and friction compensation torque Tf are calculated as described above, as in step S53, the value of multiplying all the Vg, Ts, |T|g, Sr, and Tf is calculated.

The process is applied when Vg×Ts×|T|g×Sr×Tf<3 is satisfied and is not applied when Vg×Ts×|T|g×Sr×Tf exceeds +/−3 Nm, which is because the final return torque is limited in consideration of the fail-safe of the steering system.

The value calculated as described above is used as an active return torque demand Tad, which is the final return torque as in step S60, and as in step S70, when the motor torque is generated by applying the calculated active return torque demand Tad to the motor of the steering system, the return of the steering wheel of a vehicle turning at a velocity or speed within about 5 km/h˜about 30 km/h is smoothly implemented.

Substantially, by applying the steering return logic as described above, it is possible to achieve a steering-remaining angle below about 3° in a vehicle while using a torque sensor, and this performance can remove all the problems generated when using a steering angle sensor.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method of returning a steering wheel using a motor, the method comprising:
measuring a steering torque, using a torque sensor during operation of a steering wheel;
determining a steering torque sign, and a hand-covered condition of the steering wheel using the steering torque;
determining a friction compensation torque using the measured steering torque and further using a total assist torque demand computed using a motor torque and a gear ratio;
computing an active return torque demand required to return the steering wheel using the steering torque sign, the hand-covered condition of the steering wheel, and the friction compensation torque; and
operating the motor on the basis of the computed active return torque demand value.

2. The method as defined in claim 1, further comprising measuring a speed of the vehicle when the steering wheel is operated, wherein computing the active return torque demand further uses a speed gain value assigned to the measured speed.

3. The method as defined in claim 2, wherein the steering torque sign is determined to have either the positive or the negative sign using the measured steering torque,
wherein the hand-covered condition of the steering wheel is determined using a gain value |T|g ranging from 0 to 1 which is determined using a value obtained by differentiating the steering torque.

4. The method as defined in claim 3, wherein the steering torque sign is defined as +1 when the steering torque is greater than 1 Nm, and defined as −1 when the steering torque is less than −1 Nm.

5. The method as defined in claim 3, wherein the hand-covered condition of the steering wheel is defined as 1 when the steering torque has a torque change rate smaller than 1 Nm/s so as to represent a state that a driver holds the steering wheel.

6. The method as defined in claim 1, wherein the active return torque demand is computed by multiplying the steering torque sign, the hand-covered condition of the steering wheel, and the friction compensation torque.

7. The method as defined in claim 6, wherein when the active return torque demand is smaller than a predetermined value, the motor is not operated.

8. The method of claim 1, wherein the friction compensation torque is determined using a tuning map prepared using a steering reaction force computed using the steering torque and the total assist torque demand, and frictional characteristics of a steering system of the vehicle.

9. A method of returning a steering wheel of an automobile, the method comprising:
measuring steering torque during operation of a steering wheel of an automobile;
measuring speed of the automobile;
processing the steering torque to determine a turning direction of the steering wheel and a rate of change of the steering torque;
determining if the speed falls within a predetermined range;
assigning a speed gain factor associated with the measured speed when it is determined that the speed falls within the predetermined speed range;
determining a return torque value using the turning direction of the steering wheel, the rate of change of the steering torque, and the speed gain factor to; and
operating a motor connected to and configured to rotate the steering wheel based on the return torque value, thereby returning the steering wheel.

10. The method of claim 9, wherein the predetermined speed range is from about 5 Km/hour to about 30 Km/hour.

11. The method of claim 9, further comprising:
providing a tuning map associated with friction characteristics of a steering system comprising a steering wheel; and
determining a optimal friction compensation torque using the tuning map,
wherein the optimal friction compensation torque is further used to determine the return torque value.
